(19) United States
(12) Patent Application Publication
(10) Pub. No.: US 2022/0102131 A1
(43) Pub. Date: Mar. 31, 2022

(54) ION SOURCE INCLUDING STRUCTURED SAMPLE FOR IONIZATION

(71) Applicant: Helmholtz-Zentrum Potsdam - Deutsches Geoforschungszentrum GFZ Stiftung des Offentlichen Rechts des, Potsdam (DE)

(72) Inventor: Michael Wiedenbeck, Potsdam (DE)

(73) Assignee: Helmholtz-Zentrum Potsdam - Deutsches Geoforschungszentrum GFZ Stiftung des Offentlichen Rechts des, Potsdam (DE)

(21) Appl. No.: 17/421,830

(22) PCT Filed: Jan. 10, 2020
(86) PCT No.: PCT/EP2020/050535

§ 371 Date: Jul. 9, 2021

(30) Foreign Application Priority Data
Jan. 11, 2019 (EP) 19151396.9

(51) Int. Cl. H01J 49/16; H01J 49/14; H01J 49/04

(52) U.S. Cl. CPC H01J 49/16; H01J 49/0409; H01J 49/14

(57) ABSTRACT

An ion source is provided that includes a structured sample and a method for the ionization and/or its enhancement is provided, which preferably relies on field emission and/or field ionization processes. These processes can be brought about by structures with appropriate geometries, which cause a high electric field gradient at or near the sample.

An ion source comprising a structured sample and a method for the ionization and/or its enhancement is provided, which preferably relies on field emission and/or field ionization processes. These processes can be brought about by structures with appropriate geometries, which cause a high electric field gradient at or near the sample.

### BACKGROUND OF THE INVENTION

Ions are atoms and/or molecules which have acquired a negative or positive charge through a gain or loss of at least one electron. Positive ions are produced by supplying enough energy to the atom or molecule such that at least one electron is released from its bound state. This energy can for example be applied through a collision with another particle, such as an electron, an atom, a molecule or another ion. Also, an interaction with an electric field, leading to the field ionization, or with a light beam can be used. Thermal ionization is a further possible mechanism.

Ions have many technical applications. For example, ions can be used for different methods of mass spectrometry, within particle accelerators in particle physics, for radiation therapy or in ion implantation processes for semiconductor device fabrication and material sciences.

Thus, there is huge interest in efficient ion sources. All presented methods have limited efficiencies and usually consume considerable amounts of energy. Especially processes where ions are to be produced out of solid-state materials lack efficiency. This is often due to the fact that by supplying energy to the material, also neutral particles are created, which are often of no use for the desired application. It is for example well-known that in secondary ion mass spectrometry (SIMS) only a very low percentage (often less than 0.1%) of particles of the sample substance are released as secondary ions, because most of the released particles are neutral atoms or molecules. Therefore, small samples only containing a limited number of atoms cannot be used for analysis with SIMS, for which >10⁹ atoms are typically needed for certain key applications. An increase in secondary ions with respect to all released particles by a factor of 10, 100 or even more would thus be very attractive.

Techniques using the effect of field emission are well known within material sciences, for example in Scanning tunnelling microscopy, where very small conductive tips can create very high electric field gradients, allowing electrons to tunnel between the tip and the material which is examined. Due to the small size of the tip, this effect is limited to a very small area of the surface of the material, enabling a very high resolution of the microscope. This however is impractical for the generation of large ion intensities, where the involvement of larger areas is required.

In light of these difficulties improved solutions are required for increasing the efficiency of ionization processes and providing alternative or improved ionization sources.

### SUMMARY OF THE INVENTION

An objective of the present application was to overcome the disadvantages of the prior art and to provide alternative or improved ion source and method, which is characterized by an enhanced efficiency of ionization processes

The problem is solved by the features of the independent claims. Preferred embodiments of the present invention are provided by the dependent claims.

The invention preferably relates to an ion source comprising a sample to be ionized and extraction means for generating a first electric field gradient orthogonal to the surface of the sample in order to extract and/or accelerate ions from said sample, wherein the ion source comprises a structure comprising at least two galvanically separated substructures and means for supplying one or more electric voltages to said substructures to generate a second electric field gradient in close proximity to the surface of the sample so as to improve ion production efficiency, wherein the substructures of the structure are separated at least in one region by a distance of less than 10⁻³ m and the means for supplying one or more electric voltages are configured to apply an electric voltage between said substructures to generate a second electric field gradient of at least 10⁶V/m at a zone in close proximity to the surface of the sample.

The ion source according to the invention is thus characterized by a sample onto which a structure for generating an additional (e.g. second) electric field gradient is provided to enhance the ionization.

In the context of the invention the sample on which a structure is provided may also be referred to as a “structured sample”.

In a further aspect the, the invention therefore also relates to a structured sample for use as an ion source, said structured sample comprising a substance to be ionized and a structure configured to generate an electric field gradient of at least 10⁸ V/m, at a zone preferably of at least 10 μm² in close proximity to the surface of the substance so as to improve ion production efficiency preferably via a field-emission process.

The structured sample is preferably used as an ion source. Ion sources comprise preferably substances which release a certain quantity of their constituents in form of ions, thus electrically charged atoms and/or molecules. It is preferred that the ions are positively charged for this application, which means that they feature a lack of at least one electron with respect to their neutral state.

It could also be preferred that negative ions, possessing at least one excess electron with respect to their neutral state are used.

The sample comprises or consists of preferably a substance to be ionized. The terms sample and substance (to be ionized) may thus be used interchangeably herein.

The sample or substance is preferably present as a solid-state material. It could also be preferred that the substance is a fluid, preferably a gas and/or a liquid. The ionization process of the substance can consist of supplying sufficient energy to the substance by means of collision with a beam of particles, such as electrons, atoms, or ions or by application of a light beam transferring energy. For example, sputtering could be used. Also, thermal ionization could be used.

One preferred embodiment of the ion source or structured sample comprises a substance which is to be analysed with a secondary ion mass spectrometer.

The structure is preferably configured to generate a (second) electric field. Therefore, it is preferred that the structure comprises at least two electrodes between which the electric field can be generated by applying a voltage to the at least two electrodes. The structure is preferably to be understood as an element enabling the existence of electrodes. Therefore, the electrodes can for example be represented by the whole structure, or they can be preferably a part of the structure. The structure and the electrodes can be of various shapes, they can preferably be flat or round, they can essentially be two-dimensional or three-dimensional. As an example, the structure can consist of two flat electrodes facing each other. A structure preferably furthermore comprises means to supply the electrodes with an electric voltage, such as for example a galvanic connection to a voltage supply. The structure preferably comprises electrically conductive materials which at least constitute the electrodes. It is preferred that the structure is a nanostructure or microstructure. Herein the term nanostructure or microstructure preferably relate to structures having dimensions in the range of nanometer (e.g. 1 to 1000 nm) or micrometer (e.g. 1 to 1000 μm).

The electric field gradient preferably defines a vector which represents the direction of the electric field as well as its strength. As it is convention in physics, the vector points in the direction of the force a positively charged particle would experience within an electric field. The strength of the electric field is measured in volts per meter (V/m) in accordance with the International System of Units.

It is preferred that the structure is configured to generate an electric field gradient of at least 10⁶ V/m, at least 10⁷ V/m, preferably of at least 10⁸ V/m. In general, as is known in electrodynamics, the electric field gradient will depend on the electric potential as well as the distance between the voltage supplying electrodes. In the cases where an electrostatic field is applied or is a valuable approximation to the experimental situation, the electric field gradient will principally depend on the distance between the electrodes as well as the applied voltage at the electrodes. One could for example suppose two plates which are large with respect to their separation. The electric field gradient is then approximately given by the voltage applied to the electrodes divided by their separation. An electric field gradient of 10⁸ V/m is for example generated by two electrodes separated by 100 nanometres (nm−10⁻⁹ m) featuring a voltage of only 10 V.

It is preferred that a second electric field featuring a second electric field gradient as described is generated at a zone of at least 10 μm² in close proximity to the surface of the sample or substance. The surface of the sample is preferably an interface and/or boundary of the substance and a spatial region occupied by a different matter or matter in a different physical state. It can be for example a boundary between the substance and vacuum. The zone of at least 10 μm² in close proximity to the surface is preferably a zone that has an area of at least 10 μm² when projected on the surface of the sample. The zone can be part of an area exhibiting the electric field gradient which itself is three-dimensional. It is preferred that the zone is on a preferably connected stretch. It could also be preferred that the zone is composed of several separate sub-zones. Close proximity preferably refers to a distance between the zone and the surface of the sample of less than 10 μm, preferably less than 1 μm, more preferably less than 100 nm and most preferably less than 10 nm. It could also mean that the zone directly starts at the surface of the sample. The distance is measured between the closest point of the zone to the surface and the surface via the shortest line segment.

The purpose of the generated electric field is the enhancement and/or stimulus of ion production. The following two processes can play a role in preferred embodiments.

First of all, a field emission process can occur. Field emission is the emission of electrons induced by an electric field preferably an electrostatic field, preferably from a solid surface, into a vacuum. This effect can be explained by quantum mechanics and is based on quantum tunnelling. In quantum tunnelling, a particle can traverse a potential barrier with a certain probability greater than 0, which is not possible in classical physics. The binding energy of the electron within the solid represents the potential barrier in this case. Depending on the applied electric field, the probability to tunnel through this barrier can be enhanced up to values which make this phenomenon practically relevant, meaning that probabilities above 0.1%, preferably above 1%, more preferably above 10%, most preferably above 20% and in some cases preferably above 50% can be reached. Here, this effect preferably enhances the probability of releasing an ionized particle by reducing the number of available electrons to the particle before it is released from the substance. For example, a particle released from a substance by a primary ion beam in a SIMS process is more likely a positively charged ion if at least one electron which could have been potentially bound to the particle is removed from the substance by a field emission process before the particle is released. It could also be preferred that this process implies the release of at least one electron after the release of the particle from the substance.

Secondly, field ionization processes can play a role in enhancing ion production. Field ionization is based on quantum tunnelling as well. In field ionization, an electron is removed from the initially neutral particle by enhancing its probability to traverse the potential barrier of its binding energy to the particle. The enhancement also depends on the electric field gradient the particle experiences. A neutral particle released from the substance can thus be ionized by the electric field gradient in close proximity to the surface of the substance.

It is noted that carrying out the invention is not limited to the above-mentioned processes. While as demonstrated herein the above-mentioned processes may at least partially contribute to the enhancement of ion production, further processes may also play a role. Carrying out the invention does however not depend on the exact nature of the physical processes that contribute to the enhancement. The electrical field gradient generated by the structure is preferably referred to as a “second electrical field gradient” and contributes to the enhancement of ion production as described herein. Preferably the second electric field gradient is in close proximity to the sample at least partially parallel to the surface of the sample.

Orthogonal to the surface of the sample a “first electrical field gradient” is preferably provided by extraction means in order to extract and/or accelerate ions from said sample. As extraction means for instance a further extraction electrode may be positioned above the sample, while the structure of the sample is set at a different electric potential such that an orthogonal first electrical field gradient is provided.

In a preferred embodiment the extraction means are configured for generating a first electric field gradient orthogonal to the surface of the sample the first electrical field gradient is at least 10³V/m, preferably at least 10⁴V/m, at least 10⁵V/m or at least 10⁶V/m. In case of a further extraction electrode above the sample, the first electrical field gradient may for instance be controlled by setting the voltage difference between an extraction electrode and the average voltage supplied to the structure or sample. In case of a distance of 1 m between an extraction electrode and the sample and a differential voltage of 10 kV, the first electric field gradient may have e.g. a magnitude of 10⁶ V/m.

In a particular preferred embodiment, the ion source may comprise a grounded extraction plate situated above the surface of the sample and the means for supplying one or more electric voltages to the substructures are configured to simultaneously add an extraction voltage (e.g. 10 kV) to the at least two substructures, while providing a differential voltage between the substructures (e.g. +/−3 kV). Thereby a second electrical field gradient is generated in between substructures in order to facilitate the generation of ions as described herein, while at the same time a first electric field gradient is provided orthogonal to the surface of the sample to extract and/or accelerate the produced ions, e.g. for a further analysis or for other useful purposes.

A relevant enhancement of the ionization process by at least one of the two aforementioned processes preferably takes place with the field gradient of at least 10⁸V/m. A field gradient of at least 10⁹V/m could be preferred.

It is also preferred that the structure provides means such as electrodes on the surface of an electrically non-conductive substance or a grid nearby the surface of the substance where a temporally short electric voltage pulse is generated at or near the surface. If the pulse has a temporal width which is short enough, the desired electric field gradients can be generated by the pulse. Temporal widths are in the order of 500 femtoseconds (fs−10⁻¹⁵ s) or below, preferably of 200 fs or below, more preferable 100 fs or below. The pulse preferably has a voltage of 1 kV or more, more preferably 10 kV or more, most preferably 100 kV or more.

It could be also preferred that surface plasmon polaritons (SPPs) are generated at or near the surface of the substance which cause the desired electric field gradient. Excitation of the SPPs are preferably caused by electrons or photons.

In one preferred embodiment, the enhancement of ionization is used in conjunction with Laser assisted atom probing.

Such a structured sample can enhance the efficiency of an ionization process enormously. Such an enhancement would be revolutionary to many applications relying on an efficient ionization. The means necessary for such an enhancement are very simple, easy to manufacture and cost effective. Depending on the application, time, energy and resources such as substances to be ionized could be economised. Due to the relatively large zone exhibiting the electric field gradient, the enhancement can be applied to large areas of samples and substances.

In a preferred embodiment, the structure comprises at least two galvanically separated substructures present at or near the surface of the substance. The at least two galvanically separated substructures could for example be at least two electrodes for generating the electric field gradient. The substructures could be present directly at the surface of the substance. They could for example be applied directly to the surface by an appropriate microfabrication process, such as (optical) lithography or some deposition method as e.g. chemical vapour deposition or atomic layer deposition. The substructures could also be present near the surface, which preferably means that they are not directly connected to the surface of the substance. In this case, they could be supported by some other supporting structure which holds them in place. It is preferred that there are at least two substructures. There could also be preferably 3, 4, 5, 6, 7, 8, 9, 10 or more than 10, in one preferred embodiment 20 or more substructures. The substructures preferably have a height in the order of 100 nm or less, 200 nm or less, 300 nm or less, 400 nm or less or 500 nm or less. Also, a height in the order of 1 μm or less or higher than 1 μm could be preferred. Such a structure is easy to fabricate and requires low maintenance.

It is preferred that the substructures of the structure are separated at least in one region by a distance of less than 10⁻⁴ m, less than 10⁻⁵ m, less than 10⁻⁶ m or between 10⁻⁸ m and 10⁻⁷ m.

It is further preferred that the means for supplying one or more electric voltages are configured to apply an electric voltage of at least 10 V, preferably at least 100 V or at least 1000 V, between said substructures. Ranges of voltages in between said values such as an electric voltage between 100 V and 1000 V may also be preferred.

The one region preferably comprises the zone of at least 10 pmt. The distance is preferably measured between the relevant parts of the substructures, which are preferably the parts between which an electric field gradient is applied. The distance is preferably measured along the field lines of the electric field exhibiting the desired electric field gradient. In the prior art, it would not have been possible to generate the necessary electric field gradients in sufficiently large zones, because very high voltages would have been needed. In this preferred embodiment, due to the small structures with substructures separated only over small distances, no high voltages are needed to obtain the desired effect. Instead at said preferred distances of less than 10⁻⁴ m, less than 10⁻⁵ m or less than 10⁻⁶ m voltages of at least 10V, 100V or 1000 V are sufficient to generate the necessary high second electric field gradients.

In a preferred embodiment of the invention the means for supplying one or more electric voltages of the ion sources are configured to apply an electric voltage between said substructures to generate a second electric field gradient of at least 10⁶ V/m, preferably of at least 10⁷V/m, at least 10⁸ V/m or at least 10⁹V/m. Given a known distance between the substructures a person skilled in the art may set the electric voltage between said substructures accordingly to ensure the desired magnitude of a second electric field gradient.

Means for supplying one or more electric voltages may comprise for instance contacting the structure with one or more electric conductors (and a voltages source) or a wireless power transfer, preferably either by inductive of capacitive coupling.

For controlling the various components of the ion source (for example the means for supplying one or more electric voltages to the structure or the extraction means) the ion source may comprise a control unit.

As used herein, the “control unit” preferably refers to any computing device or system having a processor, a processor chip, an integrated circuit, a microprocessor or a microcontroller to allow for an automatic control of the components of the ion source. The components of the computer system may be conventional or custom-configured for the particular implementation. Preferably the computer system has a processor, an input device such as a keyboard or mouse, a memory such as a hard drive and volatile or nonvolatile memory, and computer code (software) for controlling the components of the ion source.

The control unit may preferably comprise of an oscillator driven inverter and high voltages sources obtained from isolated transformers. The control unit may also comprise a programmable printed circuit board, microcontroller, or other device for receiving and processing data signals from the ion source.

The control unit may further comprises a computer-usable or computer-readable medium, such as a hard disk, a random access memory (RAM), a read-only memory (ROM), a flash memory etc., on which a computer software or code is installed. The computer code or software to perform the control of the components of the ion source may be written in any programming language or model-based development environment, such as but not limited to C/C++, C #, Objective-C, Java, Basic/VisualBasic, MATLAB, Simulink, StateFlow, Lab View, or assembler.

The computer software, and any functional descriptions of the computer software by description of controlling particular devices or aspects of the system described herein, are considered technical features due to a direct physical output to the ion source. Functional descriptions of software may therefore be considered as preferred and defining embodiments of the invention. The particular computer code employed is available to a skilled person and may be constructed accordingly using standard knowledge.

As used herein if in relation to components of the ion source it is stated that a “component is configured to” preferably means that a control unit is configured to regulate the components accordingly. For instance, the embodiment in which means for supplying one or more electric voltages are configured set a certain voltage or a certain electric field gradient may preferably relate to a control unit configured to regulate the means for supplying one or more electric voltages accordingly.

The term “control unit is configured to” perform a certain operational step, such as position a last in the respective mold frames and initiating an injection process, may encompass a custom-designed or standard software installed on said control unit that initiates and regulates these operational steps. Steps that have been described in relation to a method are preferably conducted by a control unit configured to this end In a preferred embodiment the substructures exhibit the geometry of a comb comprising two or more teeth elements, wherein the substructures are arranged such that the teeth elements are interleave and wherein in the zone comprises areas enclosed by teeth of the interleaved substructures.

In a preferred embodiment, the substructures comprise two or more interleaved elements with comb-like geometries and the region comprises areas enclosed by teeth of the interleaved elements, where particles for the production of ions are supplied. In this embodiment, the at least two substructures comprise or consist of elements which have a shape like a comb. Preferably, this means that each element or substructure has a lateral component with a certain amount of parallel elongated components arranged perpendicularly to the lateral component just like teeth of a comb are perpendicular to the shaft. Due to this analogy, these elongated components may also herein be called teeth. Elongated component preferably means that the components are long with respect to their width and preferably also to their height. The width preferably refers to the dimension of the teeth perpendicular to the length which can be perceived by looking at the substructure from above from where its comb-like geometry can be appreciated. The height is another dimension perpendicular to both length and width. In this context, the length could be at least two times greater than the width and the height, more preferably five times greater, 10 times greater, most preferably 100 times greater or more.

It is preferred that two or more of such elements are interleaved when presently arranged as a structure. This preferably means that the at least two comb-like elements are arranged within the same plane and that each tooth of one element is arranged in the clearance between two teeth of another element. Preferably, in this arrangement all teeth of the at least two elements (substructures) are parallel and arranged in such a way that all next-neighbour teeth have the same distance to each other. It is preferred that no tooth of one element touches any part of the at least one other element. It is further preferred that the tip of each tooth of one element may have approximately the same distance to the lateral component of the other element which it exhibits two each of its next-neighbour teeth.

As used herein, approximately the same preferably refers to two magnitudes which differentiate by less than 20%, more preferably less than 10%. It is preferred that in the case of more than two elements, only two elements are interleaved in the described manner. If all of the more than two elements are interleaved, there are preferably an even number of elements, which are grouped at each time in two elements which are interleaved.

It is preferred that a voltage is applied between the two interleaved elements (substructures), with a distance between the relevant parts of the two interleaved elements such that the desired electric field gradient can be achieved in the space between these relevant parts. In this setup, the relevant parts preferably comprise all components of the two interleaved elements which neighbour each other and between which a significant electric field is in existence when the voltage is applied. These components comprise for example all teeth which are next-neighbours but also the tip of one tooth and the part of the lateral component which is enclosed by the two neighbouring teeth of this tooth. In this embodiment, the region is composed of all spaces between the relevant parts (in particular the space between the teeth of the interleaved substructures).

It is preferred that the two or more elements are arranged directly at or on the surface of the substance. To this end common deposition and/or lithography methods can be used. Hereby, a distance of for example 100 nm between the relevant parts of two interleaved elements could be realized. With a voltage of at least 10 V, preferably at least 100 V, a field gradient of at least 10⁸V/m or 10⁹V/m, respectively, could be achieved at least in one region which is composed by the spaces between the relevant parts. Typically, the structure features a height on the order of at least one hundred nanometres which can be due to technical constraints.

In a typical ionization process, energy is brought to the surface of the substance in order to release ions from the substance.

For example, in secondary ion mass spectroscopy (SIMS), this energy could be provided by a primary ion beam focused on the surface. The yield of secondary ions obtained in this way with respect to neutral particles released by the substance could be enhanced by the applied substructures. Typically, the primary ion beam would be focused on an area where the substructures are applied. The surface of the substance covered by the substructures would in some cases not contribute to the release of particles from the substance, however due to the enhancement of ionization caused by the electric field gradient and the resulting field emission/ionization processes, this is largely compensated for.

In the depicted example of FIG. 1, also a part of the substructures would be etched by the primary ion beam due to the release of particles to the environment. However, due to the enhancement of ionization of the substance, more ionized particles of the substance can be provided for its analysis; as a result, the analysis is completed in a shorter period of time and the effect is thus negligible. The chosen height of the structure cannot however be adapted accordingly. This embodiment results in an enhancement of the ionization due to the electric field gradient over a very large area of the surface of the substance. It was surprising that with the presented interleaved comb-like geometries, the ratio between the area covered by the substructures and the region approaches the ideal value of 1 better than for other possible geometries. For this, it is desirable to choose the widths of the teeth and the lateral components as small as possible.

Technically, widths smaller than 100 μm, 10 μm or even less than 500 nm nm are easily achievable. At the same time, with the chosen geometry, the desired electric field gradient can be achieved very efficiently. In this embodiment, almost all components of the substructures contribute directly to the generation of the electric field gradient.

It is preferred that the electric voltage is simultaneously added to a voltage applied to the at least two substructures where this second voltage is used to accelerate ions. Particles can be released from the substance by bombardment of ions, as is the case for example with SIMS. In this case, typically an electric field is applied in order to accelerate the ions such that they obtain significant kinetic energy. For this, electrodes can be used between which an acceleration voltage is applied. This voltage typically is on the order of several kilo-electron volts (keV). In order to supply a practical solution, in this preferred embodiment, the substructures simultaneously act as electrode for this purpose. Therefore, a suitable voltage is simultaneously applied to the at least two substructures, at the same time with the voltage difference used for creating the desired electric field gradient. As an example, 10050 V could be applied to one substructure and 9950 V could be applied to another substructure. In this manner, an acceleration voltage is applied at the same time with a voltage difference of 100 V between the substructures. This technical solution is very economical, no separate electrodes for the acceleration of ions for the bombardment and for creation of the desired electric field gradient are needed.

In a preferred embodiment, the electric voltage applied to the structure does not vary with time and is for example a direct current (DC).

In a preferred embodiment, the electric voltage applied to the structure is at least partially a time-variable voltage. The voltage applied to the structure in order to generate the electric field gradient can be a time variable voltage, for example supplied by an alternating current (AC). This embodiment can be advantageous in order to prevent short-circuits, electron emission or leakage currents. Even though substructures between which voltages are applied are galvanically separated and between the electrodes formed by the substructures there is typically a vacuum of high quality, leakage currents or even short-circuits can emerge over time. These can also be caused by electrical elements involved in creating the voltages. Surprisingly, such problems can be prevented by using time variable voltages. The strength of the electric field for a time varying voltage has to be calculated by the methods of electrodynamics. The simple calculation presented above rather presents a more or less valid approximation in this case, depending on the experimental circumstances, as a skilled person would know.

There could also be a time-varying proportion which is due to an acceleration voltage applied simultaneously to the substructures.

It is preferred that the second electric field gradient is at least partially parallel to the surface of the sample. It is preferred that partially parallel refers to an electric field gradient which has a significant projection with the desired strength in a direction parallel to the surface of the sample. A significant portion in this context preferably means that at least 50%, preferably 60%, more preferably 70%, most preferably more than 90% of the electric field gradient exhibit such a projection. Surprisingly, with such an electric field being at least partially parallel to the surface of the sample, the enhancement of ionization it is particularly efficient.

However, in some embodiments the structure may also be positioned orthogonal to the surface of the sample.

Furthermore, if another electric field is used to accelerate particles for the bombardment of the substance, this electric field will exhibit a gradient typically normal to the surface of the structured sample for efficiency reasons. Said orthogonal electric field gradient is preferably generated by the extraction means, e.g. an extraction electrode or an extraction ground plate as described herein and referred to as a first electric field gradient. Thus, in this case the overall efficiency of the process is not diminished by counteracting projections of the partially parallel electric field on the electric field used for acceleration than in other setups.

In a further preferred embodiment, the structure is fabricated from conductive metal, conductive metal alloys and/or other electrically conductive substances. Preferably, silicon-metals are used, which have advantageous electric characteristics such as conductivity and do not oxidize or only weakly. Also, metals like gold, copper, aluminium, silver or tungsten could be used. Some metals, like copper, aluminium and silver might be disadvantageous because they rapidly oxidize. Metal alloys are preferably mixtures of metals or a metal with another element, such as for example steel, solder, pewter, duralumin, bronze and amalgams, which are preferably alloys of mercury with another metal. All these materials have favourable electric characteristics such as conductivity and are practical for fabrication of the structure.

In a further aspect the invention relates to the use of an ion source as described herein in a mass spectrometer, preferably in a secondary ion mass spectrometer.

In a further aspect of the invention, a secondary ion mass spectrometer for the analysis of a substance utilizing a structured sample as presented previously is configured to comprise means for supplying one or more electric voltages to generate the electric field gradient at the structure.

In a preferred embodiment the invention relates to a secondary ion mass spectrometer for the analysis of a substance utilizing an ion source according to any one of the previous claims, wherein the sample comprises or consists of the substance to be analysed.

As used herein the term secondary ion mass spectrometer relates to an apparatus as known in the art to perform secondary ion mass spectrometry and may comprise components used to this end such as an primary ion source, a mass analyser and a detector.

Secondary ion mass spectrometers are used to analyse compositions of solid surfaces by a so-called sputtering of the surface, thus the use of a focused primary ion beam in order to release secondary ions from the solid. As primary ion source, different types of ion guns can be used, which can be based on duoplasmatrons, electron ionization, surface ionization or liquid metal ion guns.

Different types of ions can be used, for example from noble gases, oxygen molecules, caesium and/or metals or metallic alloys. The primary ion beam can be more or less focused. Typical diameters in the order of several micrometres or even less are used. The ion beam can be continuous or pulsed.

Only a fraction of the particles released from the sample surface are actually ions. Afterwards, those ions are collected and measured with a mass spectrometer or mass analyser. For the collection, special lenses for charge particles known in prior art are used. Apparatuses to filter these particles according to their mass to charge ratios, such as sector field mass spectrometers, quadrupole mass analysers and/or time-of-flight mass analysers are employed before actual detection of the ions by detectors such as Faraday cups, electron multipliers and/or CCD screens. All the different components of such a secondary ion mass spectrometer are preferably connected through a high vacuum environment exhibiting pressures preferably of 10⁴ Pascal or below in order to provide for a large mean free path for the ions.

To increase the number of ions released from the sample, a structured sample, i.e. a sample with a structure with the characteristics as presented previously can be used. For this purpose, one or more electric voltages have to be supplied to the structure. This can be achieved by several means, for example by contacting the structure with one or more electric conductors or by wireless power transfer, preferably either by inductive of capacitive coupling. The structure has to be adapted accordingly, preferably either by supplying contacts to the one or more electric conductors or by resonant circuits and/or electrodes, respectively. By this, secondary ion mass spectrometers can be adapted very easily to achieve the enhancement of ionization by a structure as described herein. In particular, the efficiency of the method can be improved dramatically and notably very small samples containing only few atoms can be used and effectively analysed.

It could be preferred that the electric voltage is applied together with an acceleration voltage applied at or near the substance. Advantageously thereby the existing setup does not have to be modified substantially.

In a preferred embodiment, the ion source, preferably the secondary ion mass spectrometer, exhibits an analysis chamber which is designed to accommodate the structured sample and which comprises at least one feedthrough for the introduction of one or more cables supplying electric voltages to the structure of the sample. Typically, the structured sample is located in an analysis chamber. To provide means to couple a voltage applied to the structure, one or more of feedthroughs for the introduction of one or more cables which act as electric conductors is featured by the chamber. It is preferred that one feedthrough is suitable for more than one cable. It could also be preferred that there are several feedthroughs, each suitable for at least one cable. The feedthrough is characterized in that it provides a safe, low electrical resistance passage for at least one electrical conductor, while at the same time it should be impermeable for fluids like air or water in order to preserve the vacuum and the general physical conditions inside the analysis chamber. It could be preferred that the feedthrough or the complete analysis chamber is retrofittable in order to apply the new technique without having to replace complete existing secondary ion mass spectrometers. In such a way, the structured sample can be used to enhance secondary ion production for secondary ion mass spectrometers without having to modify the complete mass spectrometer setup.

It is preferred that the ion source, preferably the secondary ion mass spectrometer, comprises a sample holder suited to hold the structured sample, which is configured to comprise means to provide one or more electric voltages to the structure of the sample. The structured sample is preferably provided within a sample holder. In this embodiment, it is preferred that the sample holder comprises the means to provide the one or more electric voltages to the structure of the sample. The provision of the voltage can be either by an electric conductor or by wireless power transmission as has been presented previously. The sample holder itself could be provided with the electric voltage in the same manner. If direct electric conduction is preferred, this could be achieved by at least one cable or wire. It could also be preferred that the sample holder comprises itself conductive elements which hold the structured sample and are thus in contact with it. If the contact zones are galvanically connected to the substructures and the contact between the sample holder and the structured sample is electrically conductive, the voltage could be supplied via the at least one resulting conductive path. In such a way, a very efficient and robust supply of electric voltages to the structure of the sample can be achieved.

In a preferred embodiment, the sample holder comprises at least two galvanically separated elements, each in conductive contact with a carrier of the electric energy and each conductively connected to one or more of the at least two substructures of the structure. This is a concrete embodiment of the sample holder described previously, which is very practical. No cables which are prone to damages are needed. The sample holder synergistically supplies mechanical and electrical contacts at the same time. In addition, such a sample holder could also be fabricated easily.

It is preferred that the ion source, preferably the secondary ion mass spectrometer, employs a signal generator generating a direct current voltage and/or an alternating current voltage signal which supplies electric energy to the structure. As a signal generator, custom and/or prefabricated models could be used. The signal generator could be a type selected from the group consisting of function generators, RF and microwave generators, arbitrary waveform generators, digital pattern generators and/or frequency generators. These generators could supply a static voltage signal as well as a dynamic voltage signal. It could also be preferred that the acceleration voltage used for the primary ion beam is at least partially provided as well by the signal generator. In this way, the at least one voltage signal supplied to the structured sample could be generated easily with standard equipment.

The signal generator may be controlled by a control unit as described herein, which provides desired functions for the signals to be generated.

In a further aspect of the invention, a method for fabrication and use of an ion source described as previously, comprises:
providing a sample to be ionized and extraction means for generating a first electric field gradient orthogonal to the surface of the sample in order to extract and/or accelerate ions from said sample,
applying a structure to a sample, wherein the structure comprises at least two galvanically separated substructures separated at least in one region by a distance of less than 10⁻³ m, preferably less than 10⁻⁶ m
connecting the substructures to electric signals appropriate to generate a second electric field gradient of at least 10⁸ V/m sufficient for inducing the ionization of neutral particles at a zone at or near the surface of the sample,
supplying sufficient energy to the sample in order to generate ions and/or neutral particles,
wherein the production of ions is enhanced by the presence of the second electric field gradient and the first electric field gradient serves for extracting and/or acceleration the ions.

It is clear to a person skilled in the art that all techniques and features presented previously when describing the ion source, the structured sample and/or the secondary ion mass spectrometer equally apply to the method described herein and vice versa. For example, the structure could be applied to the sample by standard mechanical or deposition methods as have been presented previously. It is preferred that the structure is directly applied to the surface of the sample which is to be ionized. The structure can be connected to an electrical signal appropriate to generate the desired electric field gradient by the previously presented methods. The connection methods introduced for the secondary ion mass spectrometer, namely by connecting the structure to an electric conductor or by wireless power transfer, can be applied here as well.

In this method, particles are released from the sample by supplying sufficient energy to the sample. This can be achieved by particle bombardment as well as by supplying the energy through a light beam. Also, thermal ionization could be used. In this process, not only ions, but also neutral particles are released from the sample. It is the goal of the structured sample to enhance the ionization rate of the process by field emission and/or ionization processes, as has been described previously.

In a further aspect of the invention, a method is used for the fabrication and use of a structure for the ionization of a substance, comprising:
applying a structure at an interface to an area
deploying a substance across the area,
applying an electric field gradient of at least 10⁶ V/m, preferably at least 10⁸ V/m, within the area by use of a structure,
   inducing ionization of the substance, preferably by a field-emission process,
whereby the structure comprises at least two galvanically separated substructures separated at least in one region of the area by a distance of less than 10⁻³ m, preferably less than 10⁻⁶ m or between 10⁻⁸ m and 10⁻⁷ m and wherein an electric voltage of at least 10 V, preferably at least 100 V, at least 1000 V is applied between said substructures and whereas the area has a size of at least 10 μm².

In this method, it is preferred that a structure as described previously can be also applied at the interface between two areas. One area is preferably a volume which can contain a substance to be ionized. The area is thus preferably a “void”, which is configured for the reception of the substance which occupies the area at least partially. A void is preferably a volume free of matter, thus a vacuum of high quality exhibiting pressures of preferably of 10⁻⁴ Pascal or below. It can also be preferred that it contains a fluid in form of a liquid and/or a gas which is subsequently displaced by the substance to be ionized. This substance can be present in the form of a solid and/or a fluid, which is preferably a liquid and/or a gas. The interface is preferably a boundary of the substance and a spatial region occupied by a different matter or matter in a different physical state. The interface can be a boundary between the area and the substance and/or between the substance and/or the structure itself. The substance is preferably deployed in the area, this can be achieved by mechanical means or by applying a pressure gradient across the area which acts as a driving force moving the substance through the area in the case the substance is a fluid. Such a pressure gradient can be regulated in order to control the flow of the substance through the area. This flow can also be stopped in order to contain the substance in the area or a continuous flow of substance through the area can be accomplished. The structure has preferably the same characteristics as the structure of the structured sample described previously. It can preferably comprise at least two galvanically separated substructures present at or near the interface to the area.

Also, the substructures are preferably separated at least in one region of the area by a distance of less than 10⁻⁶ m, preferably between 10⁻⁸ m and 10⁻⁷ m and an electric voltage of at least 10 V, preferably between 100 V and 1000 V is applied between said substructures. The electric field gradient is preferably at least 10⁸ V/m, but it can also be preferred that it is at least 10⁷V/m or at least 10⁹V/m. In this embodiment, it is preferred that the region comprises the area. Furthermore, it can be preferred that the substructures comprise two or more interleaved elements with comb-like geometries and where the region comprises areas enclosed by teeth of the interleaved elements.

In this embodiment, it is preferred that the main effect of ionization of the substance comes through the electric field gradient that preferably causes field ionization and/or field emission and.

In one concrete realization of this embodiment, a fluid of the substance is comprised in the area, more preferably flowing through the area which interfaces with the structure, for example in the form of two or more interleaved elements with comb-like geometries, which have the above-mentioned geometrical characteristics and cause a desired electric filed gradient within the area. The substance thus directly flows through the structure, between the interleaved teeth. This causes ionization of the particles of the substance.

It can be preferred that besides the electric field gradient, additional energy is supplied to the substance in order to cause ionization of its particles. This can for example be realized though particle bombardment, thermal ionization or through a light beam focussed on the substance.

It is preferred that the area has a size of at least 10 μm². It can also be preferred that it has a size of at least 30 μm². The area can be preferably one area, which is connected, or it can be put together by several separate sub-areas.

This embodiment provides a very easy method for ionization of a substance where the required electric field gradients can be easily achieved without the requirement of high voltages.

In a further aspect of the invention the structure as described herein may be used in order to produce ions from neutral gas atoms and molecules. The invention may thus also relate to ion source as described herein, wherein the sample is a gas.

For this preferred embodiment an electrically non-conductive thin film (e.g. a polymer membrane) may be perforated at regular intervals, providing numerous micron-sized holes through which a gaseous sample can pass. It may be preferred that one side of the non-conductive thin film has the gas as a sample at low vacuum or possibly up to a pressure similar to atmospheric pressure. The other side of the non-conductive thin film may be set be at a high vacuum. The differential gas pressure causes gas atoms/molecules to move through the micron sized holes.

In close proximity to the surface of the sample, which in this case is preferably defined by the electrically non-conductive thin film present in front of the gaseous sample, a structure for generating a second electric field gradient is positioned.

Two preferred geometries for the structured ion source under these conditions may be for instance envisioned. Closely juxtapositioned substructures forming the electrodes for the generation of a second electric field gradient may be printed on the same side of the non-conductive thin film in an alternating, parallel arrangement (see FIG. 2). Alternatively, substructures forming the electrodes for the generation of a second electric field gradient may be printed on opposite sides of the non-conductive thin film (see FIG. 3).

Both arrangements advantageously allow a close spacing of the substructures to generate the desired magnitudes of electric field gradient in proximity to the passing gas molecules.

A person skilled in the art understands that technical features and advantages that have been disclosed in regard to the ion source equally apply to the different uses of an ion source as described herein and vice versa. Also, in case of a gas ion source it is e.g. preferred to have extraction means for generating a first electrical field gradient orthogonal to the surface of the sample (i.e. the non-conductive film providing micron-sized holes for the passing of gas).

For instance, it may be preferred to have a separate extraction electrode biased by e.g. several thousand Volts relative to the mean voltage on the structure. The neutral gas atoms and molecules are ionized by the second electric field gradient, while the generated ions are accelerated into the high vacuum part of the apparatus by the first, orthogonal electric field gradient provided by the extraction electrode.

In a preferred embodiment, the structure of the presented methods is applied by means of optical, electron beam and/or ion lithography.

In optical lithography, also termed photolithography or UV lithography, parts of a thin film or the bulk of a substrate are patterned. Light is used to transfer a pattern from a photomask to a light-sensitive chemical photoresist on the substrate. A series of chemical treatments then preferably engraves the exposure pattern into a material. It can also be preferred that a new material is deposited in the desired pattern upon the material underneath the photo resist.

In electron-beam lithography it is preferred to scan a focused beam of electrons to draw custom patterns on a surface covered with an electron-sensitive film called resist. This preferably enables selective removal of the exposed or the non-exposed regions of the resist by immersion into a solvent. As with photolithography, the small structures can preferably be transferred to the substrate material, often by etching.

Ion beam lithography is the practice of scanning a focused beam of ions in a patterned fashion across a surface in order to create very small patterns for the same purpose.

In this way, the structure can be produced very easily and cost-effectively. With the presented methods of fabrication, structured with the desired characteristics, in particular regarding the size and/or shape of the structure, are easily fabricated.

### DETAILED DESCRIPTION OF THE INVENTION AND EXAMPLES

It should be understood that various alternatives to the embodiments of the invention described herein may be employed in practicing the invention. It is intended that the claims of the invention define the scope of the invention and that the method and apparatus within the scope of these claims and their equivalents are covered thereby.

Without intending to be limiting, the invention will be explained in more detail with reference to exemplary embodiments and the following figures:

### BRIEF DESCRIPTION OF THE FIGURES

FIG. 1 Schematic illustration a preferred embodiment of an ion source in which the structure on exhibits two interleaved comb-like elements (A: top view. B: side view)

FIGS. 2 and 3 Schematic Illustration of a preferred embodiment for using the structure described herein as an ion gas source.

FIG. 4 Photograph of a SIMS sample holder with test structures ranging from 10 μm to 1 μm spacing and having 24 comb structures in total.

FIG. 5 Experimental data on the enhancement of the 23Na+ signal using a differential voltage of ˜2.8 kV p-p between two substructures of a 1 μm comb structure and a 250 pA 16O-primary ion beam on a 50×50 μm raster. Teeth were 1 μm wide and the gap between teeth having differing voltages was also 1 μm.

### DETAILED DESCRIPTION OF THE FIGURES

The preferred embodiment comprises two comb-like elements forming two galvanically separated substructures 3, 4 which are interleaved as shown. The interleaved teeth as well as the transverse component of each element are shown. The distance between two next-neighbour teeth as well as between the teeth-tips and the transverse component is on the order of a micrometer or less. For example, the teeth line width may be 1 μm and the distance between teeth of the respective substructures 3 and 4 may be also 1 μm. It is however not required that the width of the teeth and the spacing between the teeth is the same. The thickness of such a teeth, e.g. in form as a lithographic line (vertical direction above sample surface) can be for example between 50 nm and 500 nm, preferably on the order of 100 nm. The two elements form two electrodes which could be biased for example at +/−3 kV in order to generate the desired electrical field gradient. In order to prevent electron emission and arcing between the two structures it may be preferred to operate the voltages in an AC mode.

Preferably the ion source may comprise a grounded extraction plate 7 situated above the surface of the sample 1 and the means for supplying one or more electric voltages to the substructures 3, 4 are configured to simultaneously add an extraction voltage (e.g. 10 kV) to the at least two substructures, while providing a differential voltage between the substructures (e.g. +/−3 kV). Thereby a second electrical field gradient is generated in between the interleaving teeth of the substructures 3, 4 in order to facilitate the generation of ions as described herein, while at the same time a first electric field gradient is provided orthogonal to the surface of the sample 1 to extract and/or accelerate the produced ions, e.g. for a further use.

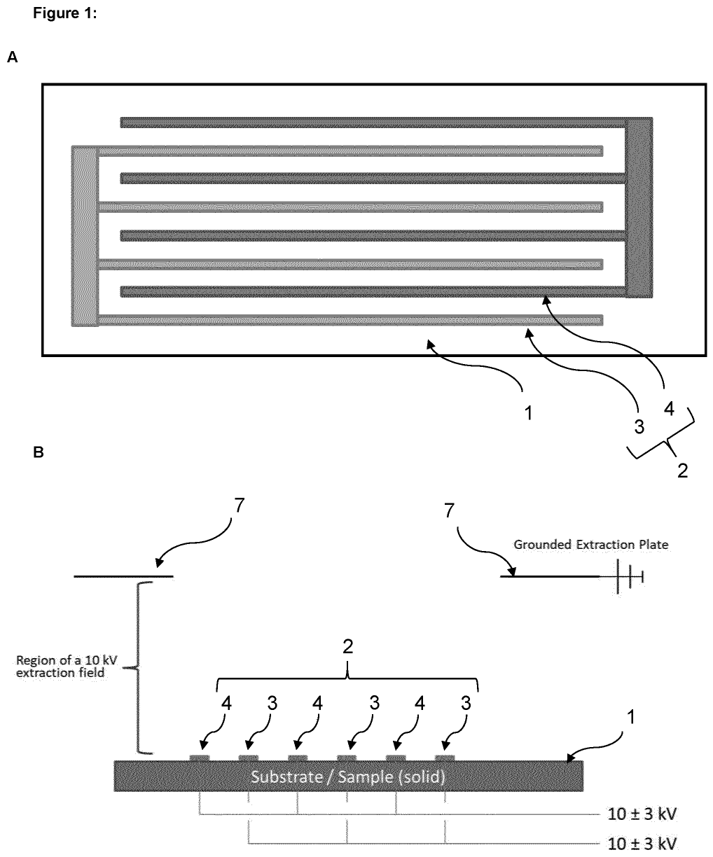

The preferred embodiment illustrated in FIG. 1 may be for instance used in a secondary ion mass spectrometer. To this end a primary ion source (not shown) may be used to generate a focussed ion bean onto the sample in order to generate secondary ions, which may be subsequently passed to a mass analyser and detector. For the primary ion source, the mass analyser and the detector different variants may be used as known in the art. Advantageously, in all cases the production of secondary ions can be reliably enhanced by the generating a second electric gradient using a structure on top of the sample as described herein.

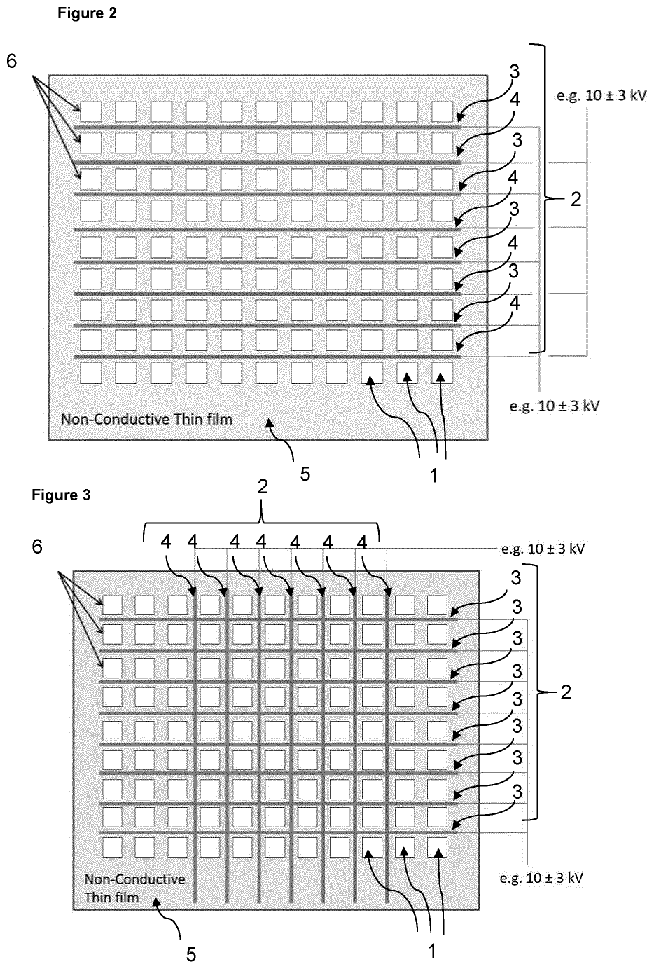

FIGS. 2 and 3 illustrates an alternative embodiment of utilizing a structure 2 as described herein in order to produce ions from neutral gas atoms and molecules.

For this preferred embodiment an electrically non-conductive thin film 5 may be perforated as shown at regular intervals, providing numerous micron-sized holes 6 through which a gaseous sample 1 can pass. One side of the non-conductive thin film 5 would have the gas as a sample 1 at low vacuum or possibly up to a pressure similar to atmospheric pressure. The other side of the non-conductive thin film 5 may be set be at a high vacuum exhibiting pressures preferably of 10⁻⁴ Pascal or below. Thereby the differential gas pressure would cause gas atoms/molecules to move through the micron sized holes.

Two preferred geometries for the structured ion source under these conditions may be envisioned.

As illustrated in FIG. 2 closely juxtapositioned substructures 3 and 4 forming the electrodes for the generation of a second electric field gradient may be printed on the same side of the non-conductive thin film 5 in an alternating, parallel arrangement,

As illustrated in FIG. 3 substructures 3 and 4 forming the electrodes for the generation of a second electric field gradient may be printed on opposite sides of the non-conductive thin film 5.

Both arrangements advantageously allow a close spacing of the substructures to generate the desired magnitudes of electric field gradient. In both cases it is preferred to have a separate extraction electrode (not shown) biased by e.g. several thousand Volts relative to the mean voltage on the two substructures 3 and 4 acting as ionization electrodes on the vacuum side of the thin film 5.

The neutral gas atoms and molecules are ionized by the second electric field gradient, while the generated ions are accelerated into the high vacuum part of the apparatus by the first, orthogonal electric field gradient provided by the extraction electrode.

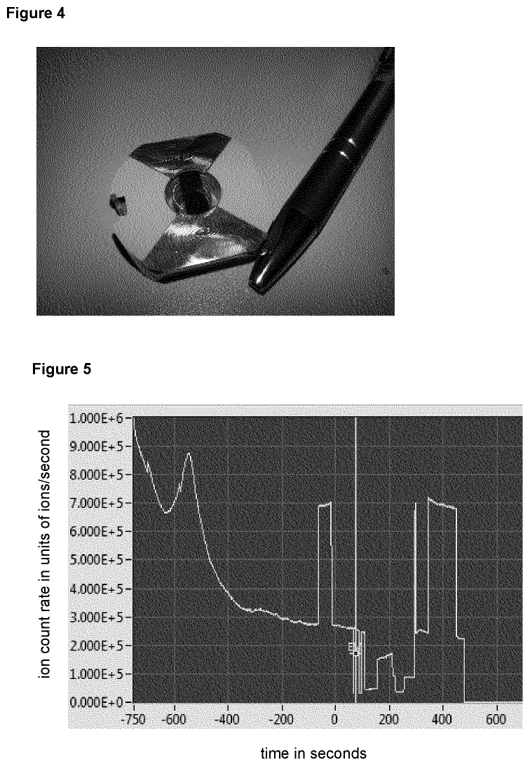

FIG. 4 shows a photograph of a SIMS sample holder with simple glass slide in the position where the structured sample would normally be located. Note the two copper contacts for providing electrical signals to the structured sample. A tip of a pen is placed for scale.

FIG. 5 shows the record of data acquired from measurement, with the x-axis showing time (in seconds) and the Y-axis showing ion intensity (in ions per second). The numerous spikes starting at time−70 s reflect the 2.8 kV p-p voltage being applied (sharp increase in ion count rate) and being removed (sharp decrease in the ion count rate) from the structured sample.

### Example 1

To demonstrate the enhanced SIMS using an ion source as proposed herein a sample stage capable of accepting two separate voltages for the sample holder was installed on a Cameca 1280. An electric feedthrough was rated at a maximum voltage of 20 kV relative to the supporting con-flat flange. During the test the SIMS ion source was operated with a DC extraction potential of 10 kV over a distance of ˜4.5 mm. This is equivalent to an orthogonal first electric field gradient of ˜2.2e+6 V/m.

The electronics provided a differential voltage of 2.8 kV peak-to-peak. An exemplary SIMS sample holder with test comb structures ranging from 10 μm to 1 μm of teeth spacing is shown in FIG. 4. The sample disk had three different types of test structures: 10 μm, 3 μm and 1 μm tooth width and gap width. For each different type 8 test structures were present. The teeth were oriented in the horizontal, so that any deflection they gave to the ions would be parallel to the entrance slit of the mass spectrometer.

A test was run with a 10 picoampere (pA) 16O-primary focused to ˜2 μm diameter beam (primary ion beam) and rastered over a 50×50 μm area with 10 kV dc and ˜1.4 kV p-p on a 3 μm comb structure. Vacuum pressure in the sample chamber was in the high e-7 Pascal range. The settings are equivalent to a second field gradient parallel to the sample surface of ˜4.7 e+8 V/m.

Using the arrangement an enhancement in the 23Na+ signal of a couple of percent on the comb structure were seen. Boosting the SIMS instrument's primary beam current to 250 pA and shifting to the 1 μm comb structure an enhancement of ˜10% between the application of no differential voltage (10 kV DC extraction only) and AC mode (1.4e+9 V/m with 10±1.4 kV applied to the two sample feedthroughs) was observed.

Providing a differential voltage of ˜2.8 kV p-p between the two substructures and using a 250 pA, 50×50 μm raster on the 1 μm comb spacing test object an enhancement of a factor of ˜2× on the 23Na+ signal was observed (see FIG. 5). The setting corresponded to a field gradient of roughly 2.8e+9 V/m parallel to the sample's surface. These data were measured on the SIMS' discrete dynode ion counting system with an integration time of 1 second. The large spikes at e.g., +350 s are when the voltage supplied to the comb was turned on and at e.g. 450 s the voltage was turned off.

A further test using identical conditions except that a 16O-primary ion beam at 1 nA was used showed an enhancement of similar magnitude.

### REFERENCE SIGNS

1 Sample or substance
2 Structure
3, 4 Substructures
5 non-conductive thin film
6 Micron-size holes allowing gas to pass through the non-conductive thin film

1. An ion source comprising a sample (1) to be ionized and extraction means for generating a first electric field gradient orthogonal to the surface of the sample (1) in order to extract and/or accelerate ions from said sample (1), characterized in that the ion source comprises a structure (2) comprising at least two galvanically separated substructures (3,4) and means for supplying one or more electric voltages to said substructures (3,4) to generate a second electric field gradient in close proximity to the surface of the sample (2) so as to improve ion production efficiency, wherein the substructures (3,4) of the structure (2) are separated at least in one region by a distance of less than 10⁻³ m and the means for supplying one or more electric voltages are configured to apply an electric voltage between said substructures to generate a second electric field gradient of at least 10⁶ V/m at a zone in close proximity to the surface of the sample (1).

2. The ion source according to claim 1, characterized in that the zone in which the second electric field gradient is generated encompasses an area of at least 10 μm².

3. The ion source according to claim 1, characterized in that the means for supplying one or more electric voltages are configured to apply an electric voltage of at least 10 V between said substructures (3,4).

4. The ion source according to claim 1, characterized in that the means for supplying one or more electric voltages are configured to apply an electric voltage between said substructures (3,4) to generate a second electric field gradient of at least 10⁶ V/m.

5. The ion source according to claim 1, characterized in that the substructures (3,4) are separated at least in one region by a distance of less than 10⁻⁴.

6. The ion source according to claim 1, characterized in that the structure (2) is positioned within a distance of less than 10 μm of the surface of the sample (1).

7. The ion source according to claim 1, characterized in that the substructures (3,4) are separated at least in one region by a distance of less than 10⁻⁶ m and wherein an electric voltage of at least 10 V is applied between said substructures (3,4).

8. The ion source according to claim 1, characterized in that the substructures (3,4) exhibit the geometry of a comb comprising two or more teeth elements, wherein the substructures (3,4) are arranged such that the teeth elements interleave and the zone comprises areas enclosed by teeth of the interleaved substructures (3,4).

9. The ion source according to claim 1, characterized in that the ion source comprises a grounded extraction plate situated above the surface of the sample and the means for supplying one or more electric voltages to the substructures (3,4) are configured to simultaneously add to an extraction voltage to the at least two substructures (3,4), while providing a differential voltage between the substructures (3,4).

10. The ion source according to claim 1, characterized in that the one or more electric voltages applied to the substructures (3,4) are at least partially time-variable voltages.

11. The ion source according to claim 1, characterized in that the second electric field gradient is at least partially parallel to the surface of the sample (1).

12. The ion source according to claim 1, characterized in that the structure (2) is fabricated from conductive metal, conductive metal alloys and/or other electrically conductive substances.

13. The ion source according to claim 1, characterized in that the ion source comprises an analysis chamber designed to accommodate the sample (1) and the structure (2), wherein the analysis chamber comprises at least one feedthrough for the introduction of one or more cables supplying electric voltages to the substructures (3,4).

14. The ion source according to claim 1, characterized in that a sample holder suited to hold the sample (1) is configured to comprise means to provide one or more electric voltages to the substructures (3,4).

15. The ion source according to claim 1, characterized in that the sample holder comprises at least two galvanically separated elements, each in conductive contact with a carrier of the electric energy and each conductively connected to one or more of the at least two substructures (3,4).

16. Use of an ion source according to claim 1 in a mass spectrometer or for the ionization of a gas or gas mixture.

17. A method for fabrication and use of an ion source in according to claim 1, comprising:
providing a sample (1) to be ionized and extraction means for generating a first electric field gradient orthogonal to the surface of the sample (1) in order to extract and/or accelerate ions from said sample (1),
applying a structure (2) to a sample (1), wherein the structure (2) comprises at least two galvanically separated substructures (3,4) separated at least in one region by a distance of less than 10⁻³ m
connecting the substructures (3,4) to electric signals appropriate to generate a second electric field gradient of at least 10⁶ V/m sufficient for inducing the ionization of neutral particles at a zone at or near the surface of the sample (1),
supplying sufficient energy to the sample (1) in order to generate ions and/or neutral particles,
wherein the production of ions is enhanced by the presence of the second electric field gradient and the first electric field gradient serves for extracting and/or acceleration the ions.

18. A method for the fabrication and use of a structure for the ionization of a substance (1), comprising:
applying a structure (2) at an interface to an area
deploying a substance (1) across the area,
applying an electric field gradient of at least 10⁶ V/m within the area by use of the structure (2),
inducing ionization of the substance (1), the structure (2) comprises at least two galvanically separated substructures separated at least in one region of the area by a distance of less than 10⁻³ m and wherein an electric voltage of at least 10 V is applied between said substructures (3,4) and whereas the area has a size of at least 10 μm².

19. The method for according to claim 17, wherein the structure (2) is applied by means of optical, electron beam and/or ion lithography.

20. The method for according to claim 18, wherein the structure (2) is applied by means of optical, electron beam and/or ion lithography.
